(19) United States
(12) Patent Application Publication
(10) Pub. No.: US 2007/0201014 A1
(43) Pub. Date: Aug. 30, 2007

(54) LIGHT IRRADIATION APPARATUS, LIGHT IRRADIATION METHOD, CRYSTALLIZATION APPARATUS, CRYSTALLIZATION METHOD, SEMICONDUCTOR DEVICE, AND LIGHT MODULATION ELEMENT

(76) Inventors: Yukio Taniguchi, Yokohama-shi (JP); Masakiyo Matsumura, Kamakura-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/674,350

(22) Filed: Feb. 13, 2007

(30) Foreign Application Priority Data
Feb. 27, 2006 (JP) 2006-049629

(51) Int. Cl. G03B 27/72

(52) U.S. Cl. 355/69

(57) ABSTRACT

A light irradiation apparatus includes a light modulation element that modulates a phase of incident light to emit the modulated light therefrom, and an image forming optical system that is arranged between the light modulation element and an irradiation target plane, and forms an image of the emitted light to irradiate the irradiation target plane with the light having a predetermined light intensity. The light modulation element has in a unit region a plurality of area ratio changing structures including a first area ratio changing structure and a second area ratio changing structure. The first area ratio changing structure has at least one first phase modulation region in which an area share ratio varies in a first direction. The second area ratio changing structure has at least one second phase modulation region in which an area share ratio varies in a second direction different from the first direction.

### CROSS-REFERENCE TO RELATED APPLICATIONS

This application is based upon and claims the benefit of priority from prior Japanese Patent Application No. 2006-049629, filed Feb. 27, 2006, the entire contents of which are incorporated herein by reference.

### BACKGROUND OF THE INVENTION

1. Field of the Invention

The present invention relates to a light irradiation apparatus, a light irradiation method, a crystallization apparatus, a crystallization method, a semiconductor device, and a light modulation element, and relates to, e.g., a technology of irradiating a non-single crystal semiconductor film with a laser beam having a predetermined light intensity distribution to generate a crystallized semiconductor film.

2. Description of the Related Art

A thin film transistor (a TFT) used for, e.g., a switching element that selects a display pixel in a liquid crystal display (an LCD) and the like is conventionally formed of amorphous silicon or poly-crystal silicon. It is known that poly-crystal silicon has a high mobility of electrons or holes than that of amorphous silicon.

Therefore, when a transistor is formed of poly-crystal silicon, a switching speed becomes higher and a display response speed also becomes higher than those in an example where a transistor is formed of amorphous silicon. Further, an LSI arranged at a peripheral portion of the device, e.g., a driver circuit or a DAC can be constituted of a thin film transistor to operate at a higher speed. Furthermore, there is also an advantage of, e.g., a reduction in design margins of other components.

Since poly-crystal silicon is made of an aggregation of crystal grains, when, switching transistor such as a TFT transistor is formed of poly-crystal silicon, crystal grain boundaries inherently present in a channel region of the transistor. These crystal grain boundaries serve as barriers, and hence a mobility of electrons or holes becomes lower than that of a TFT transistor formed of single-crystal silicon. Many thin film transistors respectively formed of poly-crystal silicon, the number of crystal grain boundaries formed in a channel region differs depending on each thin film transistor. This difference becomes unevenness, resulting in a problem of display unevenness in case of a liquid crystal display using such a transistor. Thus, in order to improve the mobility of electrons or holes and reduce unevenness in the number of crystal grain boundaries in the channel portion, a crystallization method of generating crystallized silicon or poly-crystal silicon having a large particle diameter that enables forming at least one channel region has been proposed.

As this type of crystallization method, the following technology has been conventionally proposed. That is, according to this technology, an incident laser beam is modulated into a laser beam having a V-shaped light intensity distribution that one-dimensionally varies in a predetermined direction by using a light modulation element (a phase shifter), as follows. The modulation element has a phase pattern in which an area share ratio of a phase modulation region in a unit area one-dimensionally varies in a predetermined direction. A non-single crystal semiconductor film (a polycrystal semiconductor film or a non-single crystal semiconductor film) is irradiated with this modulated laser beam, so that the film is subjected to crystal growth in the predetermined direction, thereby generating a crystallized semiconductor film (see, e.g., Y. Taniguchi, etc., “Novel Phase-modulator for ELA-based Lateral Growth of Si”, The electrochemical Society's 206th Meeting, Thin Film Transistor Technologies VII (Honolulu, Hi.)).

As shown in FIG. 13A, a conventional crystallization technology proposed in this document uses a light modulation element 101 having a phase pattern in which an area share ratio of a phase modulation region in a unit region one-dimensionally varies in a predetermined direction (a horizontal direction in FIG. 13A). In this figure, each hatched square region 101a is the phase modulation region, and its area is reduced from a central part toward a peripheral part. A laser beam modulated via this light modulation element 101 has a V-shaped light intensity distribution that one-dimensionally varies on an image plane of an image forming optical system, that is an irradiated surface of the silicon film. Specifically, when a phase modulation amount of the phase modulation region 101a of the light modulation element 101 is 60 degrees, a V-shaped light intensity distribution 102 indicated by a thick solid line in FIG. 13B is theoretically generated. Further, when a phase modulation amount of the phase modulation region of the light modulation element 101 is 180 degrees, a V-shaped light intensity distribution 103 indicated by a thick solid line in FIG. 13B is theoretically generated, and a V-shaped light intensity distribution 104 indicated by a thin solid line in FIG. 13B is actually produced. When a non-single crystal semiconductor film is irradiated with a laser beam having a V-shaped light intensity distribution generated in this manner, a crystal grows in a gradient direction of the light intensity distribution, and each needle-like crystal 105 that extends in the gradient direction from a central part where a light intensity is low is generated as shown in FIG. 13C.

In case of manufacturing a TFT in the needle-like single crystal, a carrier mobility that determines a response speed of the transistor is dependent on a direction of a channel to be formed (a direction of carrier movement or a direction from a source to a drain). That is, when a direction of a channel (a direction from a source S to a drain D) is parallel with a longitudinal direction of the needle-like crystals 111 as shown in FIG. 14A, a higher carrier mobility can be obtained than that in an example where the direction of the channel (the direction from the source S to the drain D) is vertical to the longitudinal direction of the needle-like crystals 111. That is because the crystal grain boundaries 111a that run laterally across the channel is present in the example shown in FIG. 14B, whereas the carrier is not scattered by each crystal grain boundary 111a between the needle-like crystals 111 when the direction of the channel is parallel with the longitudinal direction of the needle-like crystals 111 as depicted in FIG. 14A.

In the conventional technology, since a plurality of TFTs are respectively manufactured in the needle-like crystals whose longitudinal directions are aligned in one direction in this manner, a response speed differs depending on, e.g., a TFT having a channel direction lateral to a growth direction of the needle-like crystals and a TFT having a channel direction vertical to be same. In other words, in the conventional technology, when trying uniforming response speeds of respective TFTs manufactured in the group of the needle-like crystals whose longitudinal directions are aligned in one direction, the channel directions must be also aligned in one direction. As a result, a necessary forming area of a crystal film is totally increased, necessary wiring lines for each transistor become long, a vacant space is increased, trials and tribulations of layout are increased, and designing takes time, resulting in a severe restriction in designing a circuit.

### BRIEF SUMMARY OF THE INVENTION

It is a first object of the present invention to provide a crystallization apparatus, a crystallization method, and a light modulation element that allow each TFT having a fixed response speed to generate, e.g., a producible needle-like crystal or needle-like crystal group even if channel directions are not aligned in one direction.

To achieve this object, according to a first aspect of the present invention, there is provided a light irradiation apparatus that irradiates an irradiation target plane with light having a light intensity distribution, comprising:

a light modulation element that modulates a phase of incident light to emit the modulated light therefrom; and

an image forming optical system that is arranged between the light modulation element and the irradiation target plane, and forms an image of the emitted light to irradiate the irradiation target plane with the light having the predetermined light intensity,

wherein the light modulation element has in a unit region a plurality of area ratio changing structures including a first area ratio changing structure and a second area ratio changing structure; the first area ratio changing structure has at least one first phase modulation region in which an area share ratio varies in a first direction; and the second area ratio changing structure has at least one second phase modulation region in which an area share ratio varies in a second direction different from the first direction.

According to a second aspect of the present invention, there is provided a light irradiation apparatus that irradiates an irradiation target plane with light having a light intensity distribution, comprising:

a light modulation element that modulates incident light; and

an image forming optical system that is arranged between the light modulation element and the irradiation target plane, and forms the light intensity distribution on the irradiation target plane,

wherein the light modulation element has a plurality of modulation regions including at least one first modulation region where a first light intensity distribution in which a light intensity varies in a first direction is generated on the irradiation target plane and at least one second modulation region where a second light intensity distribution in which a light intensity varies in a second direction different from the first direction is generated on the irradiation target plane.

According to a third aspect of the present invention, there is provided a light irradiation method of using a light modulation element that modulates a phase of incident light and an image forming optical system arranged between the light modulation element and an irradiation target plane to irradiate the irradiation target plane with light having a predetermined light intensity distribution,

wherein the light irradiation method uses the light modulation element having at least one first area ratio changing structure in which an area share ratio of a phase modulation region in a unit region varies in a first direction and at least one second area ratio changing structure in which an area share ratio of the phase modulation region in the unit region varies in a second direction different from the first direction.

According to a fourth aspect of the present invention, there is provided a light irradiation method of using a light modulation element that modulates incident light and an image forming optical system arranged between the light modulation element and an irradiation target plane to irradiate the irradiation target plane with light having a predetermined light intensity,

wherein the light irradiation method uses as the light modulation element a light modulation element having at least one first modulation region where a first light intensity distribution in which a light intensity varies in a first direction is generated on the irradiation target plane and at least one second modulation region where a second light intensity distribution in which a light intensity varies in a second direction different from the first direction is generated on the irradiation target plane.

According to a fifth aspect of the present invention, there is provided a crystallization apparatus comprising: the light irradiation apparatus according to the aforementioned aspect or aspects; and a stage that holds a non-single crystal semiconductor film in such a manner that an irradiation plane of the non-single crystal semiconductor film becomes the irradiation target plane, wherein the crystallization apparatus irradiates the irradiation plane of the non-single crystal semiconductor film with the light having the light intensity distribution to form a crystallized semiconductor film.

According to a sixth aspect of the present invention, there is provided a crystallization method that uses the light irradiation apparatus or method according to the aforementioned aspect of aspects, and irradiates at least a part of a non-single crystal semiconductor film held on the irradiation target plane with the light having the light intensity distribution to form a crystallized semiconductor film.

According to a seventh aspect of the present invention, there is provided a light modulation element that modulates a phase of incident light, comprising:

a plurality of area ratio changing structures including at least one first area ratio changing structure in which an area share ratio of a phase modulation region in a unit region varies in a first direction and at least one second area ratio changing structure in which an area share ratio of the phase modulation region in the unit region varies in a second direction different from the first direction.

According to an eighth aspect of the present invention, there is provided a light modulation element that modulates incident light, comprising:

at least one first modulation region where a first light intensity distribution in which a light intensity varies in a first direction is generated on at least a part of an irradiation target plane; and at least one second modulation region where a second light intensity distribution in which a light intensity varies in a second direction different from the first direction is generated on the other part of the irradiation target plane.

It is a second object of the present invention to provide a semiconductor device, e.g., a TFT having a fixed response speed even if channel directions are not aligned in one direction.

According to a ninth aspect of the present invention, there is provided a semiconductor device manufactured by using the crystallization method according to the aforementioned aspect.

In the crystallization apparatus according to the present invention, an element, e.g., a TFT having a fixed response speed can generate a producible needle-like crystal group even if channel directions are not aligned in one direction. As a result, a necessary area of a crystal film can be suppressed, a necessary wiring line becomes short, a vacant space is suppressed, and rapid designing is enabled without trials and tribulations of layout, thus increasing a degree of freedom in designing a circuit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view schematically showing a structure of a crystallization apparatus according to an embodiment of the present invention;

FIG. 2 is a view schematically showing an internal structure of an illumination system depicted in FIG. 1;

FIGS. 3A to 3C are views schematically explaining a structure of a light modulation element according to the embodiment, in which FIG. 3A is a view showing a stripe pattern as a basic pattern of the light modulation element, FIG. 3B is a view showing an area ratio changing structure formed of a set of the stripe patterns depicted in FIG. 3A, and FIG. 3C is a view showing a light intensity distribution generated by the area ratio changing structure depicted in FIG. 3B;

FIG. 4 is a view schematically explaining a structure of the light modulation element according to the embodiment, in which a repeated pattern of the light modulation element is schematically depicted;

FIG. 5 is a view showing a light intensity distribution formed on an image plane of an image forming optical system by the light modulation element according to the embodiment;

FIG. 6 is a view showing how needle-like crystals are generated in a semiconductor film of a processing target substrate by the light modulation element according to the embodiment;

FIG. 7 is a view schematically explaining that growth directions of the needle-like crystals are possibly disordered in the embodiment;

FIGS. 8A to 8C are views schematically explaining a structure of a light modulation element according to a modification of the embodiment, in which FIG. 8A shows a first stripe pattern, FIG. 8B shows a second stripe pattern, and FIG. 8C shows an area ratio changing structure formed of a set of the first stripe patterns depicted in FIG. 8A and the second stripe patterns illustrated in FIG. 8B;

FIG. 9 is a view schematically explaining a structure of a light modulation element according to a modification of the embodiment, in which a repeated pattern of the light modulation element is schematically shown;

FIG. 10 is a view showing a light intensity distribution generated on an image plane of an image forming optical system by the light modulation element according to the modification depicted in FIG. 9;

FIG. 11 is a view schematically explaining that growth directions of needle-like crystals are stabilized in the modification of the embodiment;

FIGS. 12A to 12E are views schematically showing respective steps of manufacturing an electronic device by using the crystallization apparatus according to the embodiment;

FIGS. 13A to 13C are views for explaining a conventional crystallization technology, in which FIG. 13A is a plan view showing a part of a phase modulation element having a phase pattern in which an area share ratio of a phase modulation region in a unit region one-dimensionally varies in a predetermined direction, FIG. 13B is a view showing a light intensity distribution generated when a phase modulation amount of the phase modulation region is 60 degrees or 180 degrees, and FIG. 13C is a view schematically showing needle-like crystals formed by a laser beam having the light intensity distribution; and

FIGS. 14A and 14B are views schematically explaining an inconvenience in the conventional crystallization technology, in which FIG. 14A shows an example where a source and a drain are formed in such a manner that a direction of a channel becomes parallel with a longitudinal direction of each needle-like crystal, and FIG. 14B shows an example where a source and a drain are formed in such a manner that a direction of a channel becomes substantially vertical to a longitudinal direction of each needle-like crystal.

### DETAILED DESCRIPTION OF THE INVENTION

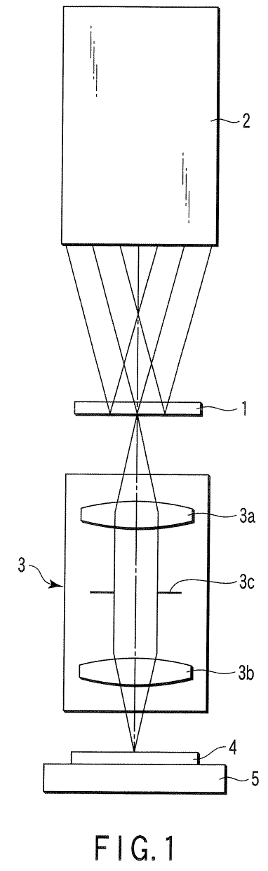

An embodiment according to the present invention will now be explained with reference to the accompanying drawings. FIG. 1 is a view schematically showing a structure of a crystallization apparatus according to an embodiment of the present invention. FIG. 2 is a view schematically showing an internal structure of an illumination system depicted in FIG. 1. Referring to FIGS. 1 and 2, a crystallization apparatus according to this embodiment includes a light modulation element 1 like a phase shifter that modulates a phase of an incident light beam to form a light beam having a predetermined light intensity distribution, an illumination system 2 that illuminates the light modulation element 1, an image forming optical system 3, and a substrate stage 5 that holds a processing target substrate 4 having a film of a semiconductor, e.g., non-single crystal silicon.

A structure and a function of the light modulation element 1 will be explained later. The illumination system 2 includes an XeCl excimer laser beam source 2a that supplies a laser beam having a wavelength of, e.g., 308 nm. Alternatively, it is possible to use other appropriate beam sources, e.g., a KrF excimer laser beam source or a YAG laser beam source having performance of emitting an energy light ray that fuses an irradiation region of the processing target substrate. A cross section of the laser beam supplied from the beam source 2a is expanded by a beam expander 2b, and then this laser beam enters a first fly-eye lens 2c.

As a result, a plurality of small light sources are formed on a rear focal plane of the first fly-eye lens 2c, and an incidence plane of a second fly-eye lens 2e is illuminated with light beams from the plurality of small light sources via a first condenser optical system 2d in a superimposing manner. Consequently, more small light sources are formed on a rear focal plane of the second fly-eye lens 2e than those on the rear focal plane of the first fly-eye lens 2c. The light modulation element 1 is illuminated with light fluxes from the plurality of small light sources formed on the rear focal plane of the second fly-eye lens 2e via a second condenser optical system 2f in a superimposing manner.

The first fly-eye lens 2c and the first condenser optical system 2d constitute a first homogenizer. This first homogenizer uniforms the laser beam emitted from the beam source 2a in relation to an incidence angle on the light modulation element 1. Further, the second fly-eye lens 2e and the second condenser optical system 2f constitute a second homogenizer. This second homogenizer uniforms the laser beam having the uniformed incidence angle from the first homogenizer in relation to a light intensity at each in-plane position on the light modulation element 1.

In this manner, the illumination system 2 irradiates the light modulation element 1 with the laser beam that has a light intensity distribution with a substantially uniform intensity as a whole. The laser beam subjected to light modulation (phase modulation) by the light modulation element 1 enters the processing target substrate 4 via the image forming optical system 3. Here, a phase pattern plane of the light modulation element 1 and the processing target substrate 4 are arranged at optically conjugate positions of the image forming optical system 3. In other words, an irradiation target plane of the processing target substrate 4 is set to a plane that is optically conjugate with the phase pattern plane of the light modulation element 1 (an image plane of the image forming optical system 3).

The image forming optical system 3 includes a front positive lens group 3a on the beam source side, a rear positive lens group 3b on the processing target substrate side, and an aperture stop 3c arranged between these lens groups. A size of an opening portion (a light transmitting portion) of the aperture stop 3c (i.e., an image-side numerical aperture of the image forming optical system 3) is set to generate a necessary light intensity distribution on the semiconductor film (an irradiation target plane) of the processing target substrate 4. The image forming optical system 3 may be a reflective optical system or a refractive/reflective optical system besides the above-explained refractive optical system.

For example, the processing target substrate 4 is obtained by sequentially forming an underlying insulating film, a non-single crystal film, e.g., an amorphous silicon film, and a cap film on, e.g., a liquid crystal display glass substrate by a chemical vapor deposition (CVD) method. Each of the underlying insulating film and the cap film may be formed by an insulating film of, e.g., SiO₂. The underlying insulating film prevents foreign particles, e.g., Na in the glass substrate from entering the amorphous silicon film when the amorphous silicon film directly comes into contact with the glass substrate, and further prevents heat of the amorphous silicon film from being directly transmitted to the glass substrate.

The amorphous silicon film is a semiconductor film to be crystallized. The cap film is heated by a part of a light beam that enters the amorphous silicon film, and stores heat having a temperature realized by this heating. A temperature in a high-temperature portion on an irradiation target plane of the amorphous silicon film is relatively rapidly decreased when incidence of the light beam is interrupted. However, this thermal storage effect alleviates this temperature-down gradient, and facilitates lateral crystal growth with a large particle diameter. The processing target substrate 4 is positioned and held at a predetermined position on the substrate stage 5 by a vacuum chuck or an electrostatic chuck.

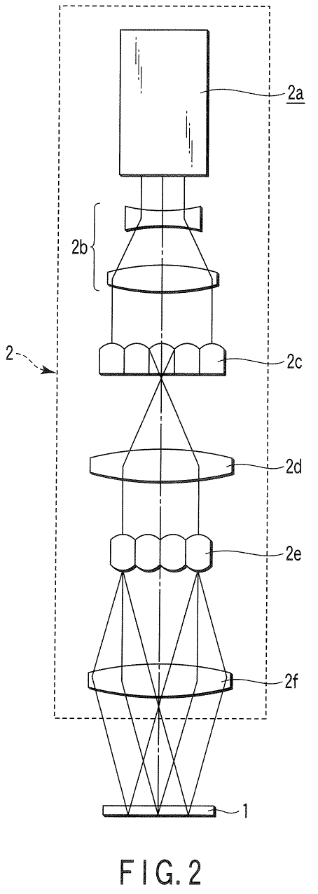

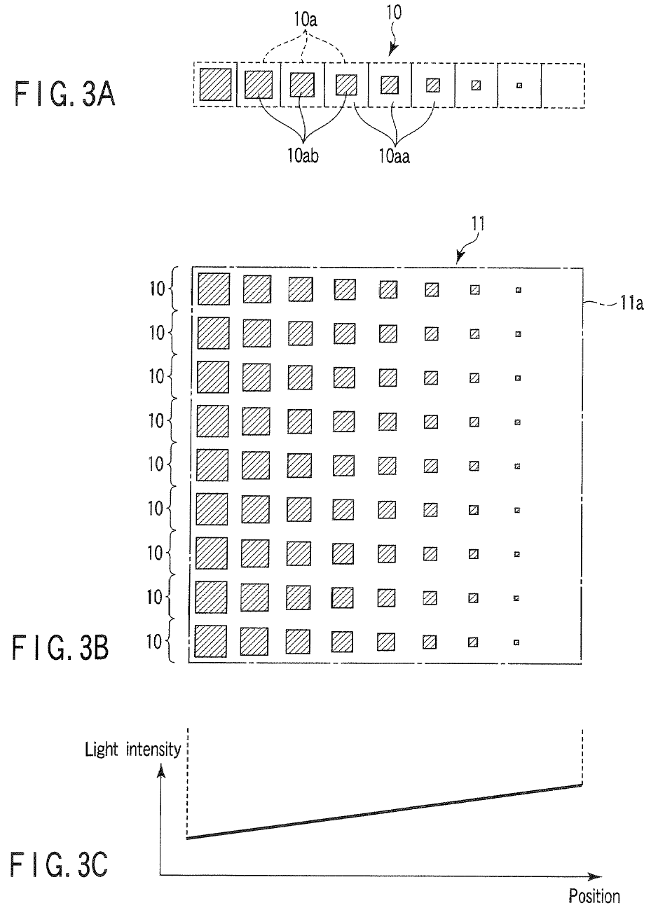

FIGS. 3A to 3C are views schematically explaining a structure of the light modulation element according to this embodiment. FIG. 3A shows a stripe pattern as a basic pattern of the light modulation element, FIG. 3B shows an area changing structure formed of a set of the stripe patterns depicted in FIG. 3A, and FIG. 3C shows a light intensity distribution generated by the area ratio changing structure depicted in FIG. 3B. As indicated by a broken line in FIG. 3A, a stripe pattern 10 includes nine (or an arbitrary plural number) square unit cells (unit regions) 10a with the same area that are aligned in a linear line to be adjacent to each other in a horizontal direction. Each unit cell 10a has a reference phase region (indicated by a blank portion in the figure) 10aa having a reference phase value of 0 degree and a rectangular, e.g., square phase modulation region (indicated by a hatched portion in the figure) having a predetermined modulation phase value (in this example, the unit cell 10a at the right end alone does not have the phase modulation region ab).

An area share ratio (a duty ratio) D of the phase modulation region 10ab in the unit cell 10a varies in a range of 0% to 50%. Specifically, in the stripe pattern 10, an area share ratio D of the phase modulation region 10ab in the unit cell 10a at the left end in the figure is 50%. An area share ration D of the phase modulation region 10ab in the unit cell 10a at the right end in the figure is 0% (because the phase modulation region 10ab is absent). An area share ratio D of the phase modulation region 10b monotonously varies between the right and the left ends. Here, the duty ratio D is defined as a smaller one of the area share ratio of the phase modulation region 10ab in the unit cell 10a and the area share ratio of the reference phase region (the phase modulation region having a phase modulation amount of 0 degree) in the unit cell 10a. Furthermore, each unit cell 10a has a size of, e.g., 1 μm×1 μm in conversion into the image plane of the image forming optical system 3, and has a dimension that is not greater than a point spread range of the image forming optical system 3.

As shown in FIG. 3B, the area ratio changing structure or pattern 11 has the nine (one or more) stripe patterns 10 shown in FIG. 3A in the perpendicular direction in the figure, the stripe pattern 10 including the nine unit cells 10a aligned in a linear line to be adjacent to each other in the horizontal direction in the figure. In this area ratio changing structure 11, the nine stripe patterns 10 have the same changing conformation of the area share ratio D. In FIG. 3B, a square 11a indicated by an alternate long and short dash line represents an outer shape of the area ratio changing structure 11 having 9×9 lattice configurations.

When using the light modulation element 1 having one or more area ratio changing structures 11 explained above, a light intensity I generated on the image plane of the image forming optical system 3 is represented by the following Expression (1). In Expression (1), D is an area share ratio (i.e., 0 to 0.5) of the phase modulation region 10ab in the unit cell 10a, and 0 is a phase modulation amount of the phase modulation region 10ab. The phase modulation amount θ is defined as being positive when a wave front protrudes in a light traveling direction.

I=(2−2 cos θ)D²−(2−2 cos θ)D+1 (1)

Referring to Expression (1), it can be understood that the light intensity I generated at a corresponding position on the image plane of the image forming optical system 3 is decreased as the area share ratio D of the phase modulation region 10ab is increased in the range of 0% to 50%. Therefore, as shown in FIG. 3C, a light intensity distribution generated on the image plane of the image forming optical system 3 in accordance with this area ratio changing structure 11 is a pattern in which the light intensity I one-dimensionally monotonously increases from a position corresponding to the left end of the square 11a toward a position corresponding to the right end of the square 1a in the figure that defines the outer shape of the duty ratio changing structure 11. In this embodiment, a change in the area share ratio D in the stripe pattern 10 is set in such a manner that the light intensity I substantially linearly varies in this manner.

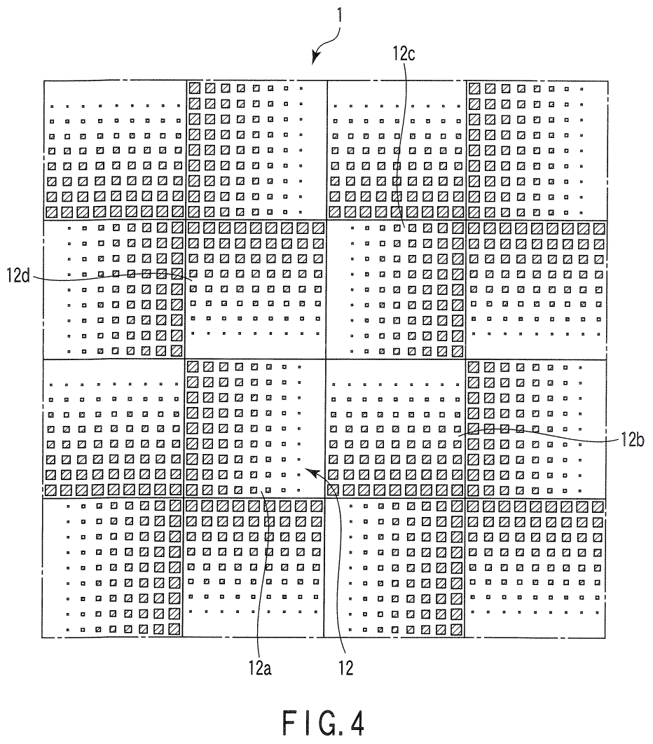

FIG. 4 is a view schematically illustrating a structure of the light modulation element or its part according to this embodiment, and schematically shows the light modulation element having a plurality of square repeated patterns. Referring to FIG. 4, each repeated pattern 12 of the light modulation element 1 is constituted of four area ratio changing structures 12a, 12b, 12c, and 12d adjacent to each other, and has a square outer shape similar to the first to the fourth area ratio changing structures 12a to 12d. The first area ratio changing structure 12a of each repeated pattern 12 is set to the same direction as the area ratio changing structure 11 depicted in FIG. 3, and has a conformation where the area share ratio D of the phase modulation region increases from the right end toward the left end in the horizontal direction in the figure.

The second area ratio changing structure 12b is set to a direction obtained by rotating the first area ratio changing structure 12a 90 degrees in the counterclockwise direction in the figure, and has a conformation where the area share ratio D of the phase modulation region increases from an upper end toward a lower end in a perpendicular direction in the figure. The third area ratio changing structure 12c is set to a direction obtained by rotting the first area ratio changing structure 12a 180 degrees in the counterclockwise direction in the figure, and has a conformation where the area share ratio D of the phase modulation region increases from the left end toward the right end in the horizontal direction in the figure. The fourth area ratio changing structure 12d is set to a direction obtained by rotating the first area ratio changing structure 12a 90 degrees in the clockwise direction in the figure, and has a conformation where the area share ratio D of the phase modulation region increases from the lower end toward the upper end in the perpendicular direction in the figure.

The light modulation element 1 is constituted by closely arranging the plurality of repeated patterns 12 each having the square outer shape in both the vertical and the horizontal directions without a gap. FIG. 4 shows one entire repeated pattern 12 arranged at the center and the twelve area ratio changing structures arranged to surround this repeated pattern 12 due to limitations of space. However, actually, in case of the light modulation element 1 having a rectangular outer shape of, e.g., several cm×several cm, approximately 1000×1000 repeated patterns 12 are included, for example. In this manner, one repeated pattern 12 in the light modulation element 1 has both the horizontal area ratio changing structures 12a and 12c in which the area share ratio D of the phase modulation region varies in the horizontal direction in the figure and the perpendicular area ratio changing structures 12b and 12d in which the area share ratio D of the phase modulation region varies in the perpendicular direction in the figure.

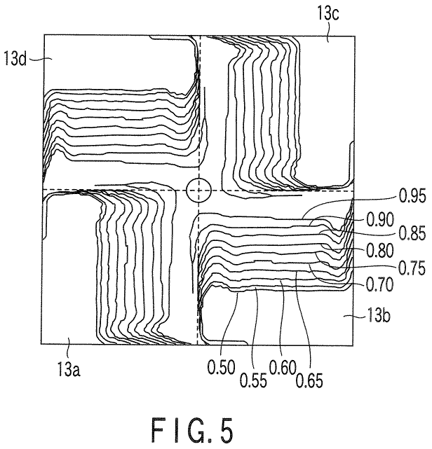

FIG. 5 is a view showing a light intensity distribution generated on the image plane of the image forming optical system, i.e., an irradiation region on the processing target substrate 4 by the light modulation element according to this embodiment. FIG. 5 shows a light intensity distribution theoretically generated on the image plane of the image forming optical system 3 in accordance with the single repeated pattern 12 in the light modulation element 1 in contour of a light intensity (a light intensity when an intensity is standardized as 1 at the time of no modulation). When calculating this light intensity distribution, a wavelength of light is set to 308 nm; an image forming magnification of the image forming optical system 3, ⅕; an object-side numerical aperture of the image forming system 3, 0.15; a numeral aperture of the illumination system 2, 0.075; and a coherence factor, i.e., a value σ (an emission-side numerical aperture of the illumination system 2/an object-side numeral aperture of the image forming optical system 3), 0.5.

Referring to FIG. 5, a light intensity distribution in which a light intensity substantially linearly increases from a left end to a right end in the horizontal direction in the figure in accordance with a changing direction of the area share ratio D of the phase modulation region in the first area ratio changing structure 12a is generated in a first irradiation region (a lower left quarter region in an entire region) 13a on the processing target substrate 4 corresponding to the first area ratio changing structure 12a. A light intensity distribution in which a light intensity substantially linearly increases from a lower end toward an upper end in the perpendicular direction in the figure in accordance with a changing direction of the area share ratio D of the phase modulation region in the second area ratio changing structure 12b is generated in a second irradiation region (a lower right quarter region in the entire region) 13b on the processing target substrate 4 corresponding to the second area ratio changing structure 12b. A light intensity distribution in which a light intensity substantially linearly increases from the right end toward the left end in the horizontal direction in the figure in accordance with a changing direction of the area share ratio D of the phase modulation region in the third area ratio changing structure 12c is generated in a third irradiation region (an upper right quarter region in the entire region) 13c on the processing target substrate 4 corresponding to the third area ratio changing structure 12c. A light intensity distribution in which a light intensity substantially linearly increase from the upper end toward the lower end in the perpendicular direction in the figure in accordance with a changing direction of the area share ratio D of the phase modulation region in the fourth area ratio changing structure 12d is generated in a fourth irradiation region (an upper left quarter region in the entire region) 13d on the processing target substrate 4 corresponding to the fourth area ratio changing structure 12d.

It can be understood that conformations of the light intensity distributions respectively generated in accordance with the area ratio changing structures 12a to 12d are different from each other in direction alone, and they are basically the same. Therefore, in order to clarify the figure, light intensity values are given to contour lines alone that are indicative of the light intensity distribution generated in accordance with the second area ratio changing structure 12b in FIG. 5. As explained above, in the light intensity distribution generated in accordance with the single repeated pattern 12, the light intensity distribution regions 13a and 13c where the light intensity substantially linearly increases in the horizontal direction in the figure are adjacent to the light intensity distribution regions 13b and 13d where the light intensity substantially linearly increases in the perpendicular direction in the figure.

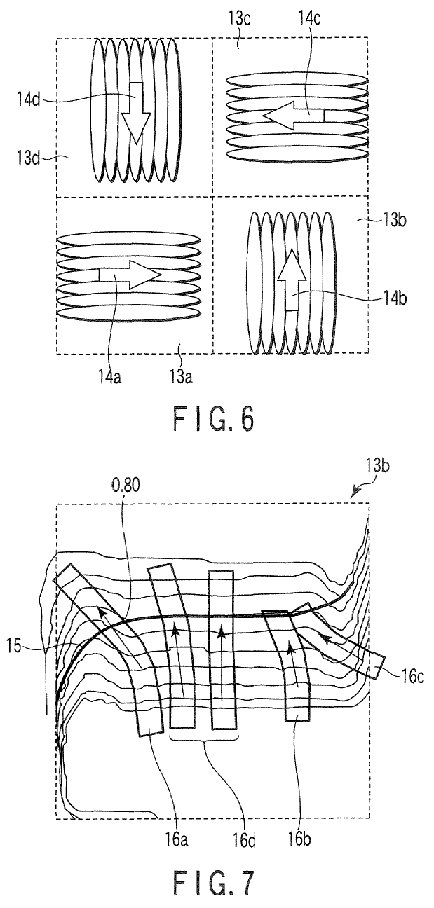

FIG. 6 is a view showing how needle-like crystals are generated on the semiconductor film of the processing target substrate by the light modulation element according to this embodiment. FIG. 6 schematically shows needle-like crystal grains produced on the semiconductor film of the processing target substrate 4 in accordance with the respective repeated patterns 12 of the light modulation element 1. Referring to FIG. 6, a group of needle needle-like crystals that spindle from a left-hand side toward a right-hand side in a light intensity gradient direction, i.e., the horizontal direction in the figure as indicated by an arrow 14a is produced in the first irradiation region 13a on the processing target substrate 4 corresponding to the first area ratio changing structure 12a. Therefore, when a TFT is manufactured in the group of the needle-like crystals produced in this region 13a while matching a channel direction with the direction indicated by the arrow 14a or an opposite direction, the TFT having a high response speed can be obtained.

Likewise, a group of needle-like crystals that spindle or extend in a light intensity gradient direction, i.e., the perpendicular direction in the figure, i.e., an upward direction is generated in the second irradiation region 13b on the processing target substrate 4 corresponding to the second area ratio changing structure 12b, and a TFT with a high response speed can be manufactured while matching a channel direction with a direction indicated by an arrow 14b in the figure. Moreover, a group of needle-like crystals that spindle from the right-hand side toward the left-hand side in a light intensity gradient direction, i.e., the horizontal direction in the figure is generated in the region 13c on the processing target substrate 4 corresponding to the third area ratio changing structure 12c, and a TFT having a high response speed can be manufactured while matching a channel direction with a direction indicated by an arrow 14c in the figure. Additionally, a group of needle-like crystals that spindle in a light intensity gradient direction, i.e., the perpendicular direction in the figure, i.e., a downward direction is produced in the fourth irradiation region 13d on the processing target substrate 4 corresponding to the fourth area ratio changing structure 12d, and a TFT having a high response speed can be manufactured while matching a channel direction with a direction indicated by an arrow 14d in the figure.

As explained above, in the crystallization apparatus according to this embodiment, even if the channel directions are not aligned in a fixed direction, it is possible to generate the needle-like crystal groups enabling manufacture of the TFTs each having a fixed response speed. As a result, a vacant space is suppressed, a necessary area of the crystal film is suppressed, and necessary wiring lines are shortened. Consequently, designing can be rapidly performed without requiring trials and tribulations of layout, thus increasing a degree of freedom in designing a circuit.

In the above-explained embodiment, the light modulation element 1 in which the first and the third horizontal area ratio changing structures 12a and 12c are adjacent to the second and the fourth perpendicular area ratio changing structures 12b and 12d without a gap is used to generate the needle-like crystal group that vertically spindles and the needle-like crystal group that horizontally spindles on the processing target substrate 4. However, the present invention is not restricted to this structure, and positions, directions, dimensions, and/or the number of the area ratio changing structures constituting the light modulation element can be determined in accordance with a desired position and a desired direction of a channel of each TFT. In other words, various modifications can be carried out with respect to structures, the total number, the number of types, arrangements (positions or directions), and others of the area ratio changing structures constituting the light modulation element.

In the foregoing embodiment, in the two area ratio changing structures adjacent to each other, the changing directions of the area share ratios D may be equal to each other, or the changing directions of the area share ratios D may be different from each other. Further, a specific-side part of the irradiation region of the processing target substrate 4 corresponding to one area ratio changing structure may be adjacent to a region with a relatively high temperature where the area share ratio D is minimum (i.e., 0%) or may be adjacent to a region with a relatively low temperature where the area share ratio D is maximum (i.e., 50%).

For example, paying attention to the second irradiation region 13b of the processing target substrate 4 corresponding to the second area ratio changing structure 12b, a part close to a neighboring portion of a region (a first irradiation region formed of the first area ratio changing structure 12a of the non-illustrated neighboring repeated pattern 12) adjacent to the right-hand side of this region 13b has a relatively low temperature, and a neighboring portion of the first irradiation region 13a adjacent to the left-hand side in the figure has a relatively high temperature.

A crystal grows after light irradiation with respect to the processing target substrate 4 is finished and the processing target substrate 4 is cooled to some extent. In a cooling process, a temperature distribution varies. Therefore, an isothermal line in molten Si corresponds to (matches with) such a contour line of the light intensity as shown in FIG. 5 immediately after end of irradiation, but it varies with time. At this time, a thermal conductivity of the substrate or the cap layer (e.g., SiO₂) is lower than that of molten Si. Therefore, in regard to a change in a temperature distribution, considering thermal conduction in molten Si alone can suffice. Accordingly, a temperature distribution T in molten Si is determined by the following thermal diffusion equation (2). In Expression (2), D is a thermal diffusion constant of molten Si, x and y are coordinates in a molten Si plane, and t is a time.

$$\frac{\partial T ( x , y , t )}{\partial t} = D ( \frac{{\partial }^{2}}{\partial {x}^{2}} + \frac{{\partial }^{2}}{\partial {y}^{2}} ) T ( x , y , t ) \qquad ( 2 )$$

Referring to Expression (2), it can be understood that a temperature is increased when a secondary derivative (a right side) concerning coordinates of a temperature is positive, and a temperature is reduced when the same is negative. That is, giving a consideration in relation to expression of isothermal lines (matching with the contour lines of the light intensity immediately after end of irradiation) depicted in FIG. 7 in which an ordinate represents a temperature and an abscissa represents a position, it can be understood that a temperature is increased at a position where the isothermal line is concave (i.e., a valley-like position), and a temperature is reduced at a position where the isothermal line is convex (i.e., a crest-like position). An actual change in temperature is determined when such small changes are accumulated with time, but this tendency is generally provided. For example, an isothermal line 15 represents how an isothermal line corresponding to a contour line indicating a light intensity of 0.8 varies after a predetermined time. As shown in FIG. 7, in the second irradiation region 13b on the processing target substrate 4 corresponding to the second area ratio changing structure 12b, the isothermal line 15 does not match with the contour line of the light intensity of 0.8 due to an influence of thermal conduction, and tends to have a shape collapsed to some extent.

On the other hand, crystal growth is predisposed to advance in a direction vertical to the isothermal line. Therefore, a needle-like crystal 16a schematically indicated by an elongated rectangular at the left end in the figure tends to curve in a direction of approaching a high-temperature side (the left side in the figure) as growth advances. Likewise, a needle-like crystal 16b that is the second from the right end in the figure tends to curve in a direction of separating from a low-temperature side (the right side in the figure). Furthermore, the needle-like crystal 16b may possibly collide with a needle-like crystal 16c at the right end in the figure that grows from the low-temperature side, and its crystal growth may be interrupted along the way. As explained above, in the foregoing embodiment, the growth direction or the growth distance of each needle-like crystal may be possibly disordered. In such a case, a group of needle-like crystals 16d alone between the needle-like crystals 16a and 16b can be effectively utilized.

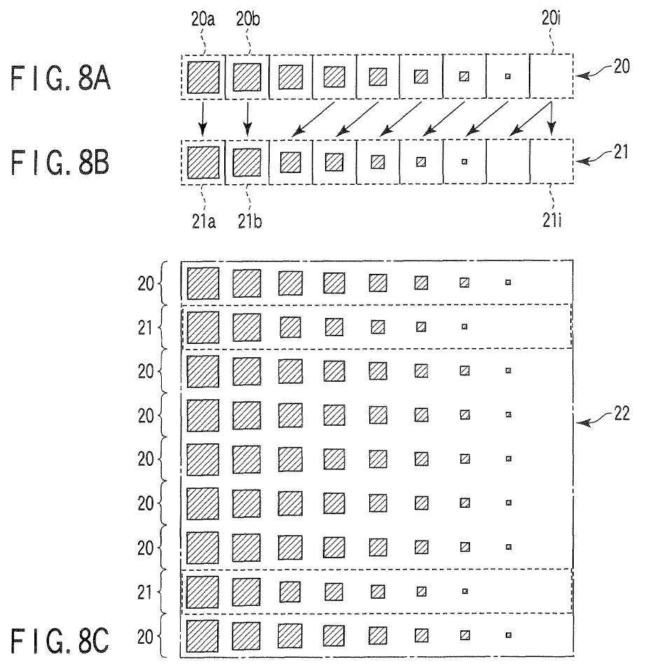

FIGS. 8A to 8C are views schematically explaining a structure of a light modulation element according to a modification of this embodiment. FIG. 8A shows a first stripe pattern, FIG. 8B shows a second stripe pattern, and FIG. 8C shows an area ratio changing structure formed of a set of the first stripe patterns depicted in FIG. 8A and the second stripe patterns illustrated in FIG. 8B. A first or a central-side stripe pattern 20 shown in FIG. 8A basically has the same structure as the stripe pattern 10 depicted in FIG. 3A. On the other hand, a second or an end-side stripe pattern 21 shown in FIG. 8B has a structure similar to the first stripe pattern 20, but a conformation of a change in the area share or duty ratio D is substantially different from that in the first stripe pattern 20.

Specifically, unit cells 21a and 21b (square unit regions indicated by a broken line in the figure) of the second stripe pattern 21 that are the first and the second from the left end in the figure respectively have the same structures as unit cells 20a and 20b of the first stripe pattern 20 that are the first and the second from the left end in the figure. Unit cells of the second stripe pattern 21 that are the third, the fourth, the fifth, the sixth, the seventh, and the eighth from the left end in the figure respectively have the same structures as unit cells of the first stripe pattern 20 that are the fourth, the fifth, the sixth, the seventh, the eighth, and the ninth (i.e., the right end) from the left end in the figure. A unit cell 21i of the second stripe pattern 21 provided at the right end in the figure has the same structure as a unit cell 20i of the first stripe pattern 20 provided at the right end in the figure.

As shown in FIG. 8C, an area ratio (duty ratio) changing structure 22 in the modification is constituted by closely arranging the seven first stripe patterns 20 and the two second stripe patterns 21 in such a manner that the stripe patterns are adjacent to each other in the perpendicular direction in the figure. In more detail, one second stripe pattern 21 is arranged at a position that is the second from the upper end in the figure, and the other second stripe pattern 21 is arranged at a position that is the second from the lower end in the figure. In case of this modification, in a light intensity distribution generated on the image plane of the image forming optical system 3 in accordance with the first stripe pattern 20, a light intensity I substantially linearly increases from a position of the first stripe pattern 20 corresponding to the left end in the figure toward a position of the same corresponding to the right end in the figure.

On the other hand, in a light intensity distribution generated on the image plane of the image forming optical system 3 in accordance with the second stripe pattern 21, the light intensity I monotonously increases from a position of the second stripe pattern 21 corresponding to the left end in the figure toward a position of the same corresponding to the right end in the figure, but it does not substantially linearly vary like that of the first stripe pattern 20. That is, in a region corresponding to a space between the unit cell 21b that is the second from the left end in the figure and the unit cell that is the third from the same in the second stripe pattern 21, the light intensity varies in a conformation different from that of a region corresponding to a space between the unit cell 20b that is the second from the left end in the figure and the unit cell that is the third from the same in the first stripe pattern 20.

As explained above, in the area ratio changing structure 22 according to the modification, conformations of changes in the area share ratios D in the nine stripe patterns are not all the same. That is, of the nine stripe patterns, a conformation of a change in the area share ratio D in the two second stripe patterns 21 arranged near the ends is substantially different from a conformation of a change in the area share ratio D in the remaining seven first stripe patterns 20. Specifically, the area share ratios D in some regions (the third and subsequent unit cells) in the second stripe pattern 21 are smaller than the area share ratios D in corresponding regions in the first stripe pattern 20. As a result, as explained above, some regions where the light intensity varies in a conformation different from that of an image plane region corresponding to the first stripe pattern 20 are present in an image plane region corresponding to the second stripe pattern 21.

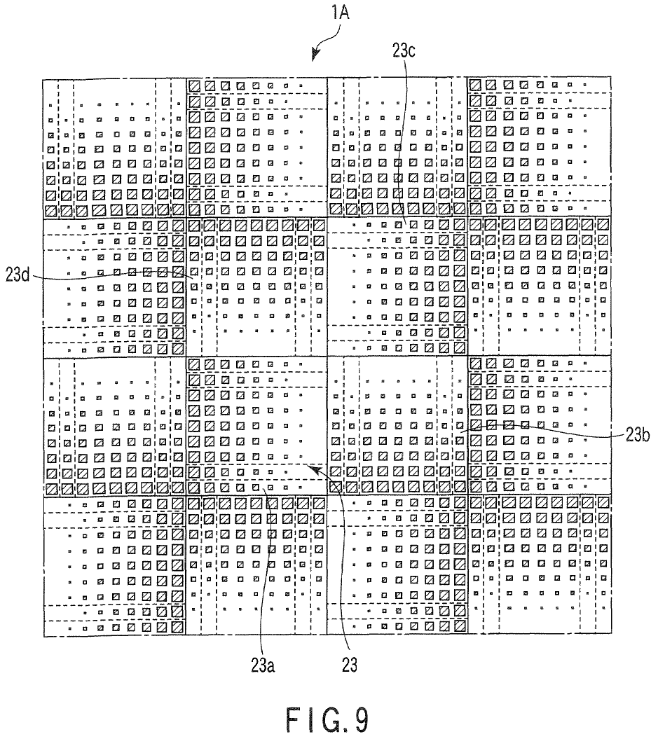

FIG. 9 is a view schematically explaining the structure of the light modulation element according to the modification of this embodiment, and schematically shows the light modulation element having a plurality of repeated patterns. Referring to FIG. 9, each repeated pattern 23 of the light modulation element 1A according to the modification is constituted of four area ratio changing structures 23a, 23b, 23c, and 23d, and has a square outer shape like the area ratio changing structures 23a to 23d. Here, the first area ratio changing structure 23a is set to a direction corresponding to the area ratio changing structure 22 depicted in FIG. 8C, and has a conformation in which the area share ratio D of the phase modulation region increases from the right end toward the left end in the horizontal direction in the figure.

The second area ratio changing structure 23b is set to a direction obtained by rotating the first area ratio changing structure 23a 90 degrees in the counterclockwise direction in the figure, and has a conformation in which the area share ratio D of the phase modulation region increase from the upper end toward the lower end in the perpendicular direction in the figure. The third area ratio changing structure 23c is set to a direction obtained by rotating the first area ratio changing structure 23a 180 degrees in the counterclockwise direction in the figure, and has a conformation in which the area share ratio D of the phase modulation region increases from the left end toward the right end in the horizontal direction in the figure. The fourth area ratio changing structure 23d is set to a direction obtained by rotating the first area ratio changing structure 23a 90 degrees in the clockwise direction in the figure, and has a conformation in which the area share ratio D of the phase modulation region increases from the lower end toward the upper end in the perpendicular direction in the figure. FIG. 9 just shows the single repeated pattern 23 arranged at the center and the 12 area ratio changing structures arranged to surround this repeated pattern 23 like FIG. 4.

In the light modulation element according to the present invention, the plurality of repeated patterns 23 do not have to have the same or substantially the same conformations, and the light modulation element may include the repeated pattern 23 whose phase modulation region is different from those of the other repeated patterns 23 or may include the single repeated pattern 23 alone. Moreover, the repeated pattern 23 does not have to include the four phase modulation regions. It is good enough for the repeated pattern 23 to have at least one first phase modulation region in which the area share ratio varies in a first direction. It is good enough for the second area ratio changing structure to have at least one second phase modulation region in which the area share ratio varies in a second direction different from the first direction. The first and the second directions do not have to be perpendicular to each other, and the first phase modulation region and the second phase modulation region can be set to have an arbitrary angle.

FIG. 10 is a view showing a light intensity distribution generated on the image plane of the image forming optical system by the light modulation element according to the modification depicted in FIG. 9. FIG. 10 shows a light intensity distribution theoretically generated on the image plane of the image forming optical system 3 in accordance with one repeated pattern 23 in the light modulation element 1A in contour of a light intensity (a light intensity when an intensity at the time of no modulation is standardized as 1) like FIG. 5. In a calculation of the light intensity distribution according to this modification, like the foregoing embodiment, a wavelength of light is set to 308 nm; an image forming magnification of the image forming optical system 3, ⅕; an object-side numerical aperture of the image forming optical system 3, 0.15; a numerical aperture of the illumination system 2, 0.075; and a coherence factor, i.e., a value σ (a numeral aperture of the illumination system 2/an object-side numeral aperture of the image forming optical system 3), 0.5.

Referring to FIG. 10, in a first irradiation region (a lower left quarter region in an entire region in the figure) 24a on the processing target substrate 4 corresponding to the first area ratio changing structure 23a, a light intensity distribution in which a light intensity substantially linearly increases from a left end to a right end in the horizontal direction in the figure is generated in a region excluding a region corresponding to the second stripe pattern 21 in accordance with a changing direction of the area share ratio D of the phase modulation region in the first area ratio changing structure 23a. In a region (a lower right quarter region in the entire region in the figure) 24b on the processing target substrate 4 corresponding to the second area ratio changing structure 23b, a light intensity distribution in which a light intensity substantially linearly increases from a lower end toward an upper end in the perpendicular direction in the figure is generated in a region excluding a region corresponding to the second stripe pattern 21 in accordance with the changing direction of the area share ratio D of the phase modulation region in the second area ratio changing structure 23b.

In a region (an upper right quarter region in the entire region) on the processing target substrate 4 corresponding to the third area ratio changing structure 23c, a light intensity distribution in which a light intensity substantially linearly increases from the right end to the left end in the horizontal direction in the figure is generated in a region excluding a region corresponding to the second stripe pattern 21 in accordance with the changing direction of the area share ratio D of the phase modulation region in the third area ratio changing structure 23c. In a region (an upper left quarter region in the entire region in the figure) 24d on the processing target substrate 4 corresponding to the fourth area ratio changing structure 23d, a light intensity distribution in which a light intensity substantially linearly increases from the upper end toward the lower end in the perpendicular direction in the figure is generated in a region excluding a region corresponding to the second stripe pattern 21 in accordance with the changing direction of the area share ratio D of the phase modulation region in the fourth area ratio changing structure 23d. In the modification, conformations of the light intensity distributions respectively generated in accordance with the first to the fourth area ratio changing structures 23a to 23d are different from each other in direction alone, and they are basically the same. Therefore, in FIG. 10, in order to clarify the figure, light intensity values are given to contour lines indicative of the light intensity distribution generated in accordance with the second area ratio changing structure 23b alone.

FIG. 11 is a view schematically explaining that a growth direction of each needle-like crystal is stabilized in the modification of this embodiment. In FIG. 11, in the second irradiation region 24b on the processing target substrate 4 corresponding to the second area ratio changing structure 23b, a thick solid line indicates an isothermal line 25 corresponding to a contour line representing a light intensity 0.8. Here, a region part adjacent to the right-hand side of the region 24b in the figure has a relatively low temperature, and a region part adjacent to the left-hand side of the same in the figure has a relatively high temperature. However, a region part corresponding to the second stripe pattern 21 functions as a buffer region part with respect to the neighboring low-temperature region part or high-temperature region part. Therefore, in particular, a temperature distribution in a central region part excluding the left end and the right end of the region 24b in the figure is hardly affected by the neighboring low-temperature region part or high-temperature region part.

As a result, in the modification according to this embodiment, a tendency of a needle-like crystal 26a shown on the left end in the figure that bends in a direction of approaching a high-temperature side (the left-hand side in the figure) is suppressed. Likewise, a tendency of a needle-like crystal 26b that is the second from the right end in the figure that bends in a direction of separating from a low-temperature side (the right-hand side in the figure) is suppressed. Further, an unnecessary needle-like crystal 26c at the right end in the figure does not collide with the needle-like crystal 26b, and its crystal growth is not interrupted. As explained above, in the modification according to this embodiment, a growth direction or a growth distance of each needle-like crystal is stabilized (a needle-like crystal having an excellent shape and direction is generated) without being substantially affected by the neighboring low-temperature region or high-temperature region. Therefore, a group of needle-like crystals 26d generated in a relatively wide region between the needle-like crystals 26a and 26b can be effectively utilized. Furthermore, in some cases, the needle-like crystals 26a and 26b each having a small bending tendency can be also effectively utilized.

In the above-explained modification, in the area ratio changing structure 22 depicted in FIG. 8C, the one second or end-side stripe pattern 21 is arranged at a position that is the second from the upper end in the figure, and the other second or end-side stripe pattern 21 is arranged at a position that is the second from the lower end in the figure. However, the present invention is not restricted thereto, and various structures can be adopted in regard to a changing conformation of the area share ratio of the phase modulation region in the second stripe pattern, positions or numbers of the second stripe patterns that should be arranged at the end or a position close to the end of the area ratio changing structure, and others. For example, each end-side stripe pattern 21 is arranged on each of both end sides of the area ratio changing structure 22 in the modification, but arranging at least one end-side stripe pattern 21 on at least one end side can suffice.

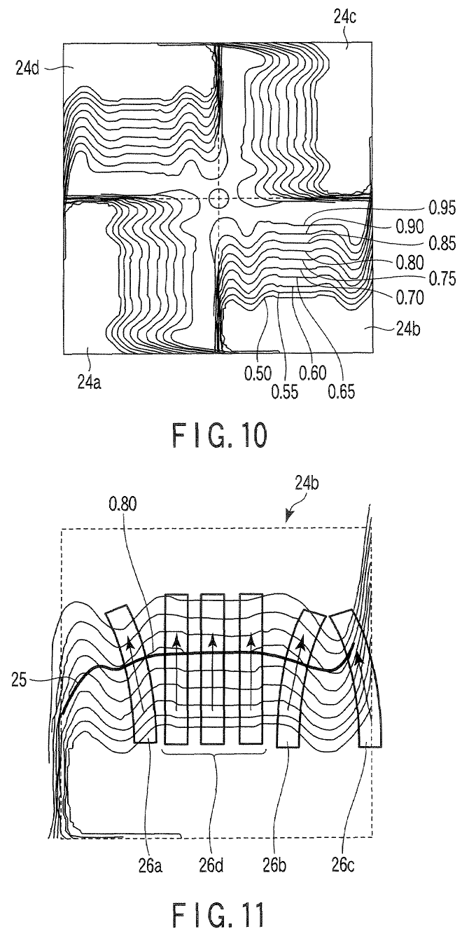

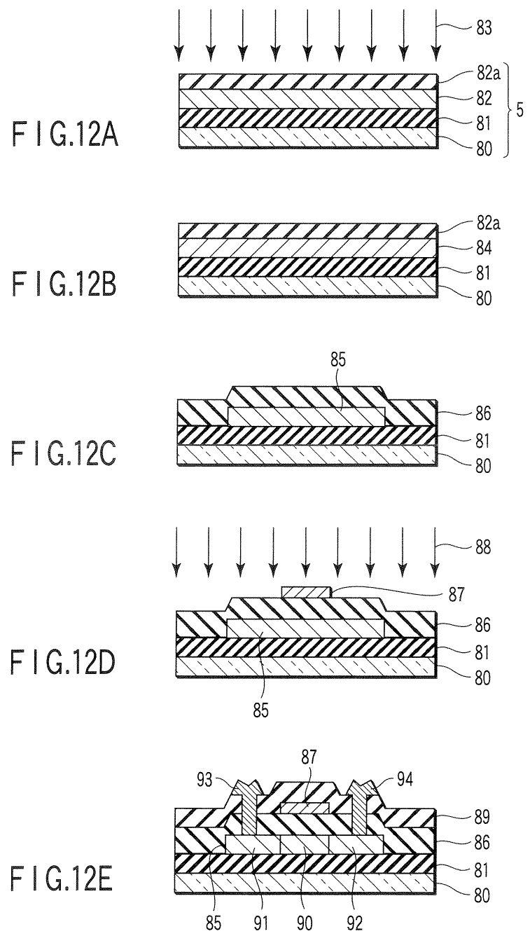

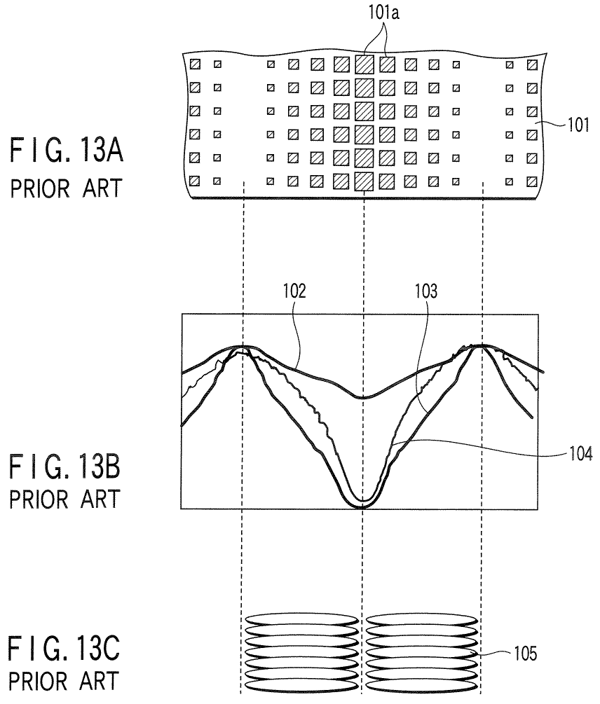

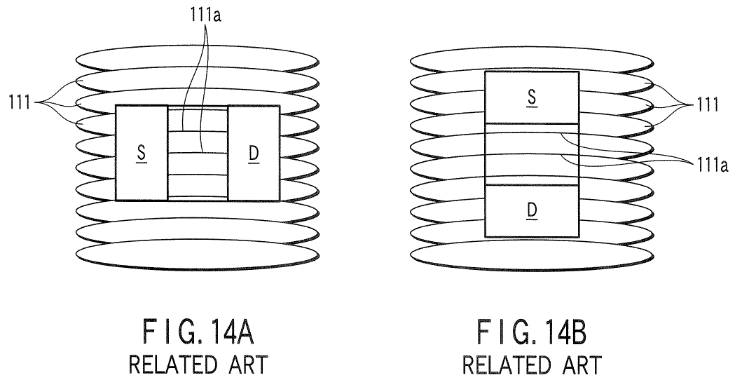

FIGS. 12A to 12E are process cross-sectional views showing respective steps of manufacturing an electronic device in a region crystallized by using the crystallization apparatus according to this embodiment. As shown in FIG. 12A, a processing target substrate 5 is prepared. The processing target substrate 5 is obtained by sequentially forming an underlying film 81 (e.g., a film like a laminated film containing SiN having a film thickness of 50 nm and SiO₂ having a film thickness of 100 nm), an amorphous semiconductor film 82 (a semiconductor film containing, e.g., Si, Ge, or SiGe having a film thickness of 50 nm to 20 nm), and a cap film 82a (e.g., an SiO₂ film having a film thickness of 30 nm to 300 nm) on a transparent insulating substrate 80 (formed of, e.g., alkali glass, quartz glass, plastic, or polyimide) by a chemical vapor deposition method or a sputtering method. Then, a predetermined region on a surface of the amorphous semiconductor film 82 is temporarily irradiated with a laser beam 83 (e.g., a KrF excimer laser beam or an XeCl excimer laser beam) once or more by using the crystallization method and apparatus adopting the light modulation element depicted in FIG. 4 or 9 according to this embodiment, thereby growing the above-explained needle-like crystals.

In this manner, as shown in FIG. 12B, a polycrystal semiconductor film or a single-crystallized semiconductor film (a crystallized region) 84 having crystal particles with a large diameter is formed in the irradiation region of the amorphous semiconductor film 82. Subsequently, the cap film 82a is removed from the semiconductor film 84 by etching. Thereafter, as shown in FIG. 12C, the polycrystal semiconductor film or the single-crystallized semiconductor film 84 is processed into, e.g., a plurality of island-shaped semiconductor films (crystallized island-shaped regions) 85 each serving as a region in which a thin film transistor is formed by using a photolithography technology as shown in FIG. 12C. An SiO₂ film having a film thickness of 20 nm to 100 nm is formed as a gate insulating film 86 on a surface of the semiconductor film 85 by using the chemical vapor deposition method or the sputtering method. Moreover, as shown in FIG. 12D, a gate electrode 87 (made of a metal e.g., silicide or MoW) is formed on a part of the gate insulating film, and the gate electrode 87 is used as a mask to implant impurity ions 88 (phosphor in case of an N-channel transistor, or boron in case of a P-channel transistor) into the semiconductor film 85 as indicated by arrows. Then, annealing processing (e.g., at 450° C. for one hour) is carried out in a nitrogen atmosphere to activate the impurity, thereby forming a source region 91 and a drain region 92 in the island-shaped semiconductor film 85 on both sides of a channel region 90. A position of such a channel region 90 is set in such a manner that a carrier moves in a growth direction of each needle-like or elongate crystal. Then, as shown in FIG. 12E, an interlayer insulating film 89 that covers the entire product is formed, and contact holes are formed in this interlayer insulating film 89 and the gate insulating film 86, and then a source electrode 93 and a drain electrode 94 are formed in the holes so that they are respectively connected with the source region 91 and the drain region 92.

At the above-explained steps, when the gate electrode 87 is formed in accordance with a position in a plane direction of each crystal having a large particle diameter of the polycrystal semiconductor film or the single-crystallized semiconductor film 84 generated at the steps depicted in FIGS. 12A and 12B, thereby forming the channel 90 below the gate electrode 87. With the above-explained steps, a polycrystal transistor or a thin film transistor (TFT) in the single-crystallized semiconductor can be formed. The thus manufactured polycrystal transistor or single-crystallized transistor can be applied to a drive circuit of a liquid crystal display (a display) or an EL (electroluminescence) display or an integrated circuit, e.g., a memory (an SRAM or a DRAM) or a CPU. The processing target in the present invention is not restricted to one on which a semiconductor device is formed, and the semiconductor device is not restricted to a TFT either.

In the above explanation, the present invention is carried out by using a phase shift type light modulation element as the light modulation element. However, the present invention is not restricted thereto. The present invention can be carried out by using a light modulation element adopting other modes, e.g., a transmission type light modulation element having a predetermined transmission pattern or a reflection type light modulation element having a predetermined reflection pattern, or a light modulation element that is a combination of these elements having a first modulation region where a first light intensity distribution in which a light intensity varies in a first direction of the light modulation element is generated on an irradiation target plane and a second modulation region where a second light intensity distribution in which a light intensity varies in a second direction different from the first direction is generated on the irradiation target plane.

Additionally, the present invention is applied to the crystallization apparatus and the crystallization method of irradiating the non-single crystal semiconductor film with light having a predetermined light intensity distribution to generate the crystallized semiconductor film in the above explanation. However, the present invention is not restricted thereto, and can be generally applied to a light irradiation apparatus that forms a predetermined light intensity distribution on a predetermined irradiation target plane via the image forming optical system.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A light irradiation apparatus that irradiates an irradiation target plane with light having a light intensity distribution, comprising:
a light modulation element that modulates a phase of incident light to emit the modulated light therefrom; and
an image forming optical system that is arranged between the light modulation element and the irradiation target plane, and forms an image of the emitted light to irradiate the irradiation target plane with the light having the predetermined light intensity,
wherein the light modulation element has in a unit region a plurality of area ratio changing structures including a first area ratio changing structure and a second area ratio changing structure; the first area ratio changing structure has at least one first phase modulation region in which an area share ratio varies in a first direction; and the second area ratio changing structure has at least one second phase modulation region in which an area share ratio varies in a second direction different from the first direction.

2. The light irradiation apparatus according to claim 1,
wherein the first direction is substantially perpendicular to the second direction.

3. The light irradiation apparatus according to claim 1 or 2,
wherein the first area ratio changing structure has a plurality of first stripe patterns that are arranged in a direction substantially perpendicular to the first direction, each first stripe pattern including a plurality of first unit regions that are aligned in a line in the first direction, and
the second area ratio changing structure has a plurality of second strip patterns that are arranged in a direction substantially perpendicular to the second direction, each second strip pattern including a plurality of second unit regions that are aligned in a line in the second direction.

4. The light irradiation apparatus according to claim 3,
wherein changes in the area share ratios in the plurality of stripe patterns of at least one of the first area ratio changing structure and the second area ratio changing structure have conformations substantially equal to each other.

5. The light irradiation apparatus according to claim 3,
wherein changes in the area share ratios in the plurality of stripe patterns of at least one of the first area ratio changing structure and the second area ratio changing structure substantially differ depending on at least one stripe pattern and the plurality of other stripe patterns.

6. The light irradiation apparatus according to claim 5,
wherein the at least one stripe pattern includes an end-side stripe pattern positioned on at least on end side in a direction substantially perpendicular to the first direction in the at least one area ratio changing structure, and the plurality of other stripe patterns include central-side stripe patterns positioned on a central side in the direction substantially perpendicular to the first direction in the at least one area ratio changing structure.

7. The light irradiation apparatus according to claim 5,
wherein the area share ratios in some regions in the at least one stripe pattern are smaller than the area share ratios in corresponding regions in the plurality of other stripe patterns.

8. A light irradiation apparatus that irradiates an irradiation target plane with light having a light intensity distribution, comprising:
a light modulation element that modulates incident light; and
an image forming optical system that is arranged between the light modulation element and the irradiation target plane, and forms the light intensity distribution on the irradiation target plane,
wherein the light modulation element has a plurality of modulation regions including at least one first modulation region where a first light intensity distribution in which a light intensity varies in a first direction is generated on the irradiation target plane and at least one second modulation region where a second light intensity distribution in which a light intensity varies in a second direction different from the first direction is generated on the irradiation target plane.

9. The light irradiation apparatus according to claim 8, wherein the first direction is substantially perpendicular to the second direction.

10. A light irradiation method of using a light modulation element that modulates a phase of incident light and an image forming optical system arranged between the light modulation element and an irradiation target plane to irradiate the irradiation target plane with light having a predetermined light intensity distribution,
wherein the light irradiation method uses the light modulation element having at least one first area ratio changing structure in which an area share ratio of a phase modulation region in a unit region varies in a first direction and at least one second area ratio changing structure in which an area share ratio of the phase modulation region in the unit region varies in a second direction different from the first direction.

11. A light irradiation method of using a light modulation element that modulates incident light and an image forming optical system arranged between the light modulation element and an irradiation target plane to irradiate the irradiation target plane with light having a predetermined light intensity,
wherein the light irradiation method uses as the light modulation element a light modulation element having at least one first modulation region where a first light intensity distribution in which a light intensity varies in a first direction is generated on the irradiation target plane and at least one second modulation region where a second light intensity distribution in which a light intensity varies in a second direction different from the first direction is generated on the irradiation target plane.

12. A crystallization apparatus comprising: the light irradiation apparatus according to claim 1 or 2; and a stage that holds a non-single crystal semiconductor film in such a manner that an irradiation plane of the non-single crystal semiconductor film becomes the irradiation target plane, wherein the crystallization apparatus irradiates the irradiation plane of the non-single crystal semiconductor film with the light having the light intensity distribution to form a crystallized semiconductor film.

13. A crystallization method that uses the light irradiation apparatus according to claim 1 or 2 or the light irradiation method according to claim 10 or 11, and irradiates at least a part of a non-single crystal semiconductor film held on the irradiation target plane with the light having the light intensity distribution to form a crystallized semiconductor film.

14. A semiconductor device manufactured by using the crystallization method according to claim 13.

15. A light modulation element that modulates a phase of incident light, comprising:
a plurality of area ratio changing structures including at least one first area ratio changing structure in which an area share ratio of a phase modulation region in a unit region varies in a first direction and at least one second area ratio changing structure in which an area share ratio of the phase modulation region in the unit region varies in a second direction different from the first direction.

16. The light modulation element according to claim 15, wherein the first direction is substantially perpendicular to the second direction.

17. The light modulation element according to claim 15 or 16,
wherein the first area ratio changing structure includes a plurality of first stripe patterns that are arranged in a direction substantially perpendicular to the first direction, each first stripe pattern including a plurality of first unit regions aligned in a line in the first direction, and
the second area ratio changing structure includes a plurality of second stripe patterns that are arranged in a direction substantially perpendicular to the second direction, each second stripe pattern including a plurality of second unit regions aligned in a line in the second direction.

18. The light modulation element according to claim 17,
wherein changes in the area share ratios in the plurality of stripe patterns of at least one of the first area ratio changing structure and the second area ratio changing structure have conformations substantially equal to each other.

19. The light modulation element according to claim 17,
wherein changes in the area share ratios in the plurality of stripe patterns of at least one of the first area ratio changing structure and the second area ratio changing structure substantially differ depending on at least one stripe pattern and the plurality of other strip patterns.

20. The light modulation element according to claim 19,
wherein the at least one stripe pattern includes an end-side stripe pattern positioned on at least one end side in a direction substantially perpendicular to the first direction in the at least one area ratio changing structure, and the plurality of other strip patterns include central-side stripe patterns positioned on a central side in the direction substantially perpendicular to the first direction in the at least one area ratio changing structure.

21. The light modulation element according to claim 19,
wherein the at least one stripe pattern includes end-side stripe patterns positioned on both end sides in a direction substantially perpendicular to the first direction in the at least one area ratio changing structure, and the plurality of other stripe patterns include central-side stripe patterns positioned between the end-side stripe patterns.

22. The light modulation element according to claim 19,
wherein the area share ratios in some regions in the at least one stripe pattern are smaller than the area share ratios in corresponding regions in the other stripe patterns.

23. A light modulation element that modulates incident light, comprising:
at least one first modulation region where a first light intensity distribution in which a light intensity varies in a first direction is generated on at least a part of an irradiation target plane; and at least one second modulation region where a second light intensity distribution in which a light intensity varies in a second direction different from the first direction is generated on the other part of the irradiation target plane.

24. The light modulation element according to claim 23,
wherein the first direction is substantially perpendicular to the second direction.
